(19) United States
(12) Patent Application Publication
(10) Pub. No.: US 2014/0310280 A1
(43) Pub. Date: Oct. 16, 2014

(54) SYSTEM AND METHOD FOR DISCOVERY, GROUPING AND SHARING OF MEDIA CONTENT

(71) Applicant: MediaHound, Inc., Culver City, CA (US)

(72) Inventors: John Addison McCaleb, Los Angeles, CA (US); Drew Wolfe, Sacramento, CA (US)

(73) Assignee: MediaHound, Inc., Culver City, CA (US)

(21) Appl. No.: 14/056,801

(22) Filed: Oct. 17, 2013

Related U.S. Application Data
(60) Provisional application No. 61/715,176, filed on Oct. 17, 2012.

(51) Int. Cl. G06F 17/30

(52) U.S. Cl. CPC G06F 17/30522
USPC 707/737

(57) ABSTRACT

A system and method for simplifying discovery, grouping and sharing of entertainment content, including media content, live shows and events, and the availability of such content.

### BACKGROUND

Ascertaining the availability, pricing, and format quality of particular movies, music, books, live shows and events, games, and other media content generally involves searching a variety of databases, and thus is time-consuming and inefficient. One approach to addressing this problem is disclosed in US Patent Publication No. 2011/0307830. However, there remains a need for better solutions.

### FIGURES

FIG. 1 is a diagram illustrating an embodiment of the present system.

FIG. 2 is another diagram illustrating an embodiment of the present system.

FIG. 3 is an illustration of an embodiment of the present system as implemented on the screen of a mobile device, comprising a content groupings interface.

FIG. 4 is an illustration of the embodiment of the present system shown in FIG. 3, showing actions available through a menu button.

FIG. 5 is an illustration of the embodiment of the present system shown in FIG. 3, showing pricing for certain content available from a particular content provider.

FIG. 6 is an illustration of the embodiment of the present system shown in FIG. 3, showing communication actions available through a menu button.

FIG. 7 is an illustration of an embodiment of the present system as implemented in an internet browser, comprising a content groupings interface.

### DESCRIPTION

### Definitions

As used herein, the following terms and variations thereof have the meanings given below, unless a different meaning is clearly intended by the context in which such term is used.

“Aggregator” refers to computer software that collects and combines predetermined information or types of information from multiple online sources.

“Brokering” refers to the process of placing a user of the present system in contact with a provider of one or more media items, and/or with facilitating or accomplishing a transaction whereby a media item is sold, rented, or otherwise provided to a user.

“Content grouping record” refers to data indicative of a predetermined set of media items.

“Content record” refers to data indicative of a particular media item.

“Distribution status” refers to data which identifies whether a media item is available for rental, sale, or in any other manner. Such data further preferably identifies a time period of availability of the media item, as well as a provider and/or location for the media item, such as a location, venue, and/or retail outlet offering the media item.

“Location unit” refers to computer software that identifies a geographical location associated with a user of the present system. Location information of a user can be obtained in a variety of ways, for example by multilateration or triangulation of signals between the radio towers of a cellular network, the use of a global positioning system (GPS), or identifying the location of a wireless access point.

“Media,” “media items,” and “entertainment content” refer to creative, intellectual, or artistic works or collections of works, such as literary works, motion pictures, choreography, musical compositions, sound recordings, paintings, drawings, sculptures, photographs, computer software, radio and television broadcasts, and games, including both live and pre-recorded performances of such works. Such media items can be grouped according to the present method.

“Performance” refers to an event in which an individual or group of individuals speak, provide music, and/or otherwise behave in a particular way for another group of people (i.e., an audience).

“Web widget” refers to a software application that can be downloaded, installed, and executed by an internet browser application on a host device, such as a computer. Web widgets generally display information, graphics, and/or other content within a web page and typically occupy a portion of a webpage. Web widgets also typically process and/or display information obtained from one or more other websites.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### System and Method

The present application is directed to a system and method for simplifying the discovery, grouping and sharing of media content as well as the availability of such content for a consumer. The following description contains specific information pertaining to the implementation of the present invention. One skilled in the art will recognize that the present invention may be implemented in a manner different from that specifically discussed in the present application. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

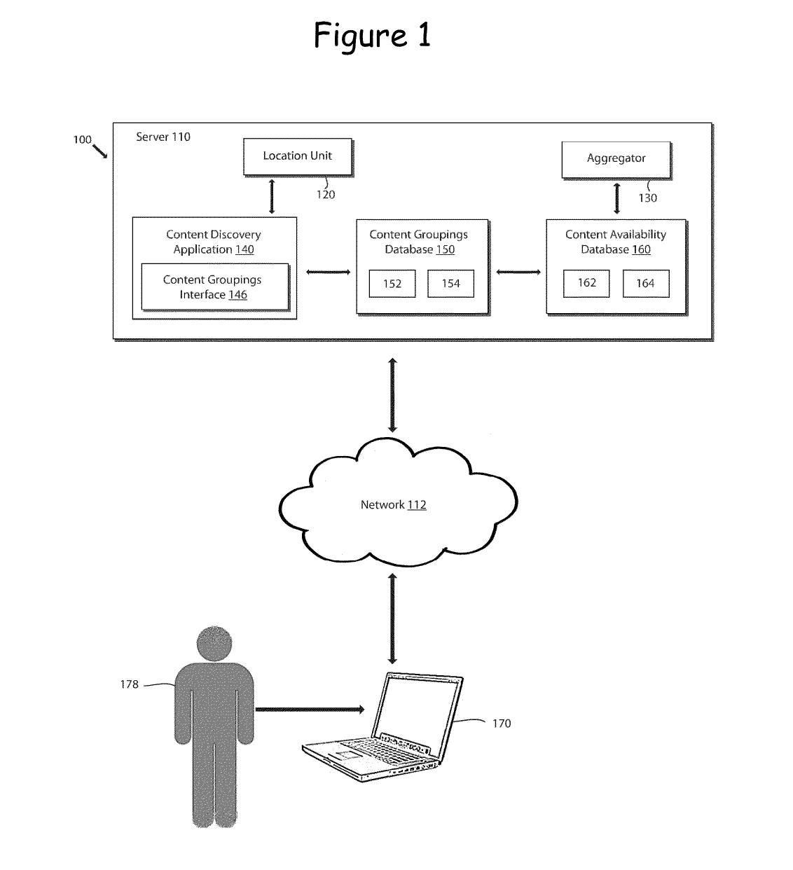

FIG. 1 shows a block diagram of a system for simplifying the discovery, grouping and sharing of content and content availability for a consumer, according to one embodiment of the present invention. In the embodiment of FIG. 1, system 100 comprises a server 110 including a location unit 120, aggregator 130, content discovery application 140, content groupings interface 146, content grouping database 150 including content grouping records 152 and 154, and content availability database 160 including content records 162 and 164. Content records 162 and 164 comprise identifiers of entertainment content, while content grouping records 152 and 154 comprise discrete collections or lists of content records. Content grouping records 152 and 154 and content records 162 and 164 are shown as merely representative entries in content grouping database 150 and content availability database 160. As such, content grouping records 152 and 154 and content records 162 and 164 are proxies for a plurality of content records, which may number from hundreds to millions of content records, for example, stored in content grouping database 150 or content availability database 160. Also included in FIG. 1 are network 112, client computer 170, and consumer 178.

Although client computer 170 is represented as a personal computer (PC) in FIG. 1, in other embodiments client computer 170 may comprise another type of mobile or stationary personal communication device or system, such as a tablet computer, mobile telephone, personal digital assistant (PDA), gaming console, television, or home entertainment system, for example. It is further noted that although the embodiment of FIG. 1 depicts location unit 120, aggregator 130, content discovery application 140, content groupings interface 146, content grouping database 150, and content availability database 160 as mutually residing on server 110 for conceptual clarity and economy of presentation, other arrangements are contemplated by the inventors.

For example, in other embodiments, some or each of location unit 120, aggregator 130, content discovery application 140, content groupings interface 146, content grouping database 150, and content availability database 160 may be remote from one another but interactively linked in the manner shown in FIG. 1, over a communication network, such as network 112. In those latter embodiments, server 110 may be seen to correspond to multiple servers, such as two to six servers, for example, for supporting communication among location unit 120, aggregator 130, content discovery application 140, content groupings interface 146, content grouping database 150, and content availability database 160. Moreover, in one embodiment, location unit 120 may be omitted from system 100 entirely.

According to the embodiment of FIG. 1, consumer 178 may utilize content discovery application 140, which may be downloaded to client computer 170 over network 112, for example, to access one or more of content records 162 and 164 stored in content availability database 160, in order to ascertain a distribution status of the content corresponding to those content records, and preferably also pricing for content which is available through distribution. Content records 162 and 164 may be periodically refreshed or updated by data provided from aggregator 130, which may, for example, pull Really Simple Syndication (RSS) data feeds according to one or more updating schedules. In addition, according to the specific embodiment shown in FIG. 1, content discovery application 140 can be configured to utilize location unit 120 to identify a geographical location associated with consumer 178, such as a location or address corresponding to communications received by server 110 from client computer 170, for example. As a result, content discovery application 140 can provide consumer 178 with information regarding the availability of content of interest to consumer 178 that is both substantially up-to-date and specific to the location of consumer 178.

Content discovery application 140 may be configured to provide a consumer interface enabling consumer 178 to ascertain the availability of desired content by viewing, sorting, and selecting one or more graphical or textual representations corresponding respectively to content records 162 and 164. Content discovery application 140 may utilize more than one visual array, and more than one combination of visually emphasized active graphical representations selectable by consumer 178 and visually de-emphasized inactive graphical representations not selectable by consumer 178, to enable consumer 178 to identify and access a desired content record. That is to say, a collection of content records corresponding to entertainment content such as books, music, feature films, or a television (TV) series or episode, for example, may be depicted by respective graphical representations and searched or filtered by consumer 178 utilizing content discovery application 140.

Various embodiments of the present invention allow consumer 178 to interact with content records that are represented graphically, and to filter the display characteristics of the graphically represented content records based on filtering criteria. The filtering organizes search results for easy viewing. According to one embodiment, the graphical representations are visual depictions corresponding to content records, such as content records 162 and 164. Content records 162 and 164 may include metadata about an integral unit of content such as a book, feature film, play, musical track or album, for example. The metadata may include substantially unchanging metadata such as the title of the content unit, actors or characters appearing in the content, an author, director, or creator of the content, a content description, or its runtime or rating, for example, to assist consumer 178 in filtering the content records so as to identify a record corresponding to a unit of desired content. In addition, the metadata may include updateable metadata such as the distribution status of the content in various regional distribution markets, as well as providers such as venues and retail outlets offering the content, and the cost of obtaining or enjoying the content from those providers, for instance.

For example, content discovery application 140 may be configured to display graphical representations corresponding to a plurality of content records including content records 162 and 164 in an inventory array, arranged in a grid pattern, for example, as active graphical representations selectable by consumer 178. In one embodiment, for example, the content records can correspond to music singles and/or albums, and their graphical representations can take the form of thumbnails (small images) representing album or single cover art, or other key art. In the event that consumer 178 were to discover a single or album of interest by visual inspection of the thumbnails, consumer 178 can access metadata relevant to that music by selecting its respective representation, such as by executing a mouse click or providing a touch-screen input to the display of client computer 170. One skilled in the art will recognize there are many more representations, including graphical and textual, corresponding to a plurality of content records including content records 162 and 164. These representations could include textual lists, individual textual representations for a single content record, or any number of other representations of content records 162 and 164, including representations of content records together with content records of a different entertainment type, such as books and movies represented within the same collection.

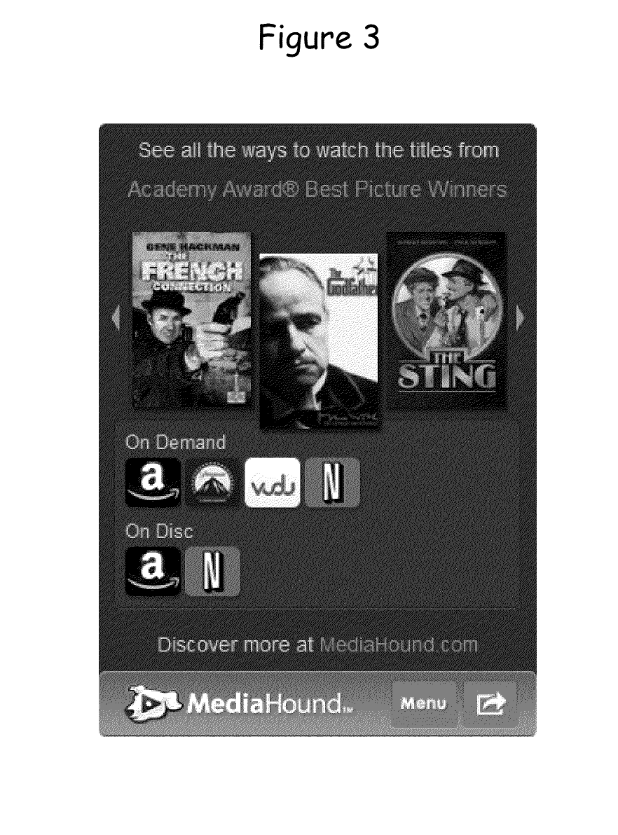

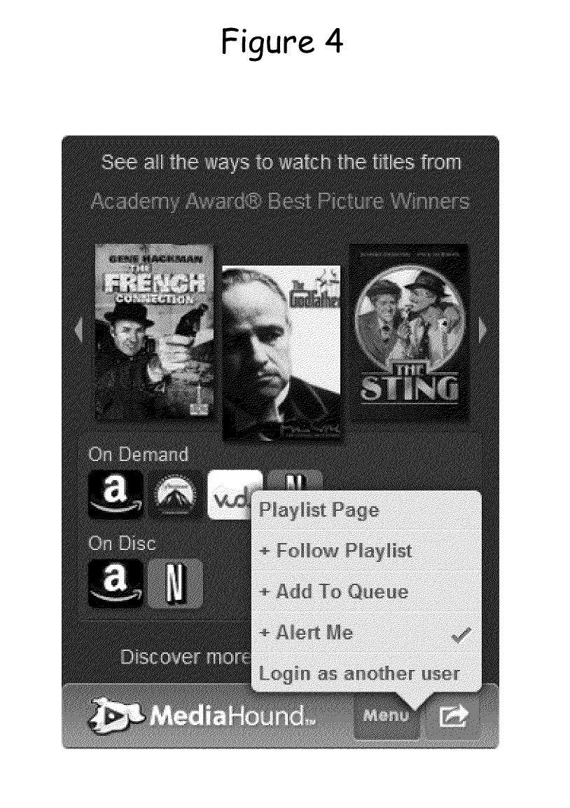

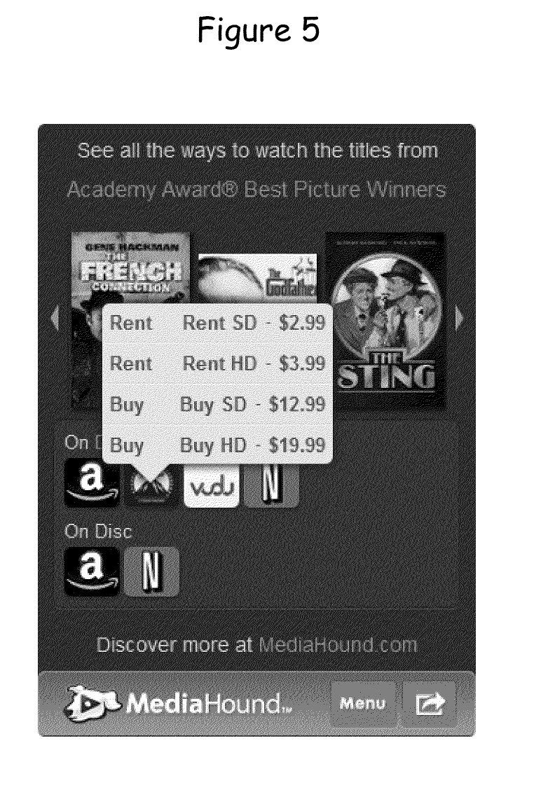

In response to data related to consumer 178, such as an input corresponding to selection of a thumbnail representation of a particular feature film or movie by consumer 178, content discovery application 140 can be configured to determine the geographical location of consumer 178 utilizing location unit 120, to store a user's actions to discern behavior with the intent of improving both global system recommendations as well as recommendations tailored to a specific user, and to display an information pane corresponding to the selected movie content and including selectable display features, such as icons, toolbars, or radio buttons, for example, indicating the distribution status of the movie. Such selectable display features are shown, for example, in the screen shots shown in FIGS. 3-7. Additionally, the information pane may display icons, toolbars or radio buttons, for example, providing tools to simplify discovery, grouping and sharing of content and content availability by consumer 178. In one example, the information pane may display and icon indicating content grouping records, such as content groupings records 152 and 154, within content groupings database 150 that contain the selected movie. This is just one embodiment and many other tools aimed at simplifying discovery, grouping and sharing of content and content availability by consumer 178 could be used. Alternatively, data related to consumer 178 may be historical data of previous selections by consumer 178, or preference settings previously chosen by consumer 178 and enabling content discovery application 140 to simplify discovery of content by consumer 178 without requiring any additional inputs by consumer 178.

For instance, if consumer 178 has previously established a preference for action movies, or if consumer 178 affirmatively provides an input selecting a thumbnail corresponding to the movie “Black Hawk Down,” an information pane for “Black Hawk Down” can be displayed to consumer 178. Such an information pane may include a display feature indicating that the movie is available as entertainment content, as well as perhaps a display feature indicating that movie is available as an event performance, such as an in-theater screening of the film for a live audience. In response to an input from consumer 178 selecting one of the display features indicating a particular distribution status, content discovery application 140 may then identify a provider for that combination of content and state of availability, for example, according to the location of consumer 178.

Content discovery application 140 may be configured to provide an interface enabling consumer 178 to group content records such as content records 162 and 164 to create content grouping records such as content grouping records 152 and 154 to simplify discovery, grouping and sharing of content records 162 and 164 for a consumer. For example, consumer 178 may group the movie “Black Hawk Down” with the movie “Top Gun” if the user wishes to create a content grouping record containing movies directed by brothers Ridley and Tony Scott. This is just one example of a content grouping record. Consumer 178 may create other content grouping records based on themes, content consumer 178 prefers or enjoys, content consumer 178 desires to consume at a future date, or any number of other reasons. Content grouping records 152 and 154 can contain any number of content records, including content records corresponding to any entertainment content such as books, music, feature films, live shows and events, or a television (TV) series or episode, for example. Content grouping records 152 and 154 may also contain other content grouping records, for example a content grouping record containing all “Star Wars” related content records, including books, live shows and events, games, songs, television series and movies, or may contain a content grouping record within the parent “Star Wars” grouping record for all “Star Wars” movies.

To continue with the specific example introduced above with reference to FIG. 1, if consumer 178 were to create a content grouping record containing the movies “Black Hawk Down” and “Top Gun”, consumer 178 may also include content records for soundtrack CDs or songs associated with those movies as well as the book “Black Hawk Down: A Story of Modern War” by Mark Bowden, and the content grouping record for all Ridley Scott movie soundtrack albums in the content grouping record. In this example, consumer 178's content grouping record would contain various forms of entertainment content including movies, books, songs and albums as well as associated content grouping records. This content grouping record allows consumer 178 to group all associated metadata for the included content records. The metadata may include updateable metadata such as the distribution (availability) status of the content in various regional distribution markets, as well as providers, venues, and retail outlets offering the content and the cost of obtaining or enjoying the content from those providers, for instance. Consumer 178's content grouping record would provide for simplified access to its associated content records for consumer 178. Consumer 178 may also share or distribute this content grouping record through inbuilt utilities which utilize integrated third party social networks, the system's own social core construct, and email, among other means by which to easily allow other consumers to access the content grouping record and its associated content records.

Various embodiments of the present invention allow consumer 178 to interact with content grouping records 152 and 154 and their associated content records 162 and 164. For example, within content discover application 140, consumer 178 may access a graphical or textual representation of all or some of the content grouping records within content groupings database 150. Additionally, consumer 178 may utilize content grouping interface 146 to display a graphical or textual representation of content records 162 and 164 within content grouping records 152 and 154. In these examples, content grouping records 152 and 154 and their associated content records 162 and 164 may be represented in a similar manner to the graphical and textual representation and filtration of content records 162 and 164 within content discovery application 140 as previously described.

In this example, consumer 178's interactions with content records associated with the content grouping record represented through content groupings interface 146 may appear similar to how consumer 178 may interact with all content records within content availability database 160 through content discover application 140. Accessing content grouping records 152 and 154 through content groupings interface 146 provides consumer 178 with a specific subset of all content records within content availability database 160 as defined by content grouping records 152 and 154, which are defined by consumer 178, another consumer or anyone else. Consumer 178 may share content grouping records 152 or 154 via a hyperlink, URL or other method, directing other consumers to content grouping records 152 and 154 through content groupings interface 146. This access to a grouping of content records simplifies the discovery and sharing of content and content availability.

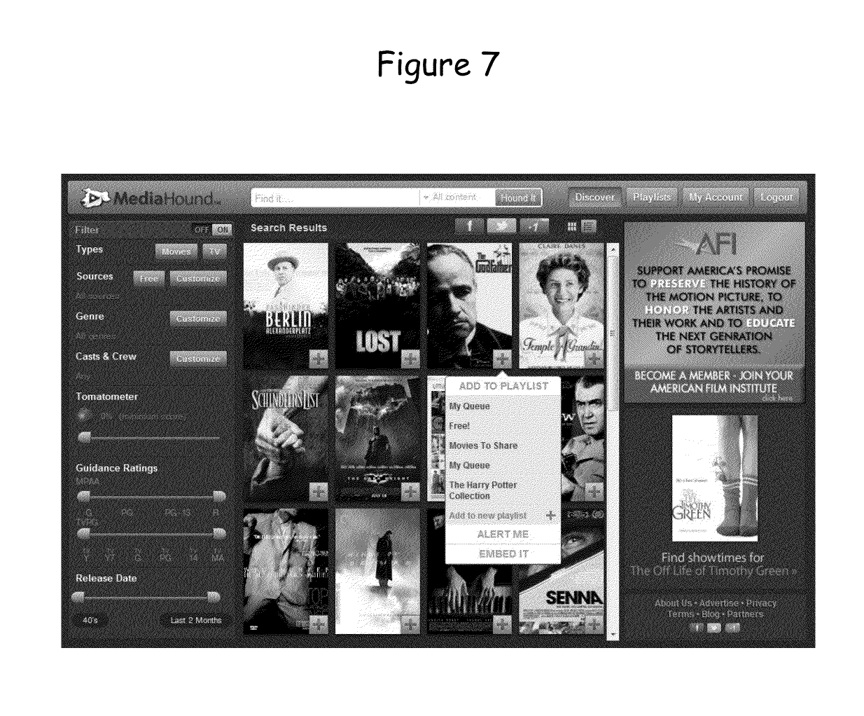

Additionally, consumer 178 may also access content grouping records 152 or 154 through an alternative web-connected application, such as a website, blog, or any other application, as shown in FIG. 7. For example, the alternative web application may represent content grouping records 152 or 154 graphically through the use of an embeddable widget or any number of other textual and graphical means for representing content grouping records or content records, including hyperlinks, browser plugins, or other representations. These representations may represent content records in similar manners to the graphical and textual representations and filtrations of content records within content discovery application 140 as previously described, or in another manner. For example, a website with limited space may embed a widget containing only a textual representation of content records containing the content record titles and URL links to the corresponding content records within content discovery application 140 for access to all associated metadata, including distribution status.

In another example, an embeddable web widget can be configured to display graphical representations corresponding to a plurality of content records including content records 162 and 164, for example arranged in a grid pattern in an inventory array as active graphical representations selectable by consumer 178. In one embodiment, the content records can correspond to music albums and movies, and their graphical representations can take the form of thumbnails representing album cover art, a movie poster, or other graphics representative of such works. In the event that consumer 178 were to discover an album or movie of interest by visual inspection of the thumbnails, consumer 178 can access metadata relevant to that music or movie by selecting its respective representation, such as by executing a mouse click or providing a touch-screen input to the display of client computer 170. This execution can result in access to metadata relevant to that content record within the widget or by linking via URL to the content record within content discovery application 140, or can result in access to a preview or full performance of the work within the widget, depending on the consumer's access rights and/or on the configuration of the widget. For example, if consumer 178 were to discover a movie or album of interest, consumer 178 can access a theatrical trailer for that movie or song preview for that album by selecting its respective representation, such as by executing a mouse click or providing a touch-screen input to the display of client computer 170. In another example, if consumer 170 retained a prior license to the content record, consumer 170 may be able to view or listen to a full performance of the content record, such as by playing a full song or album by authenticating through a streaming music subscription service or accessing the content record on client computer 170.

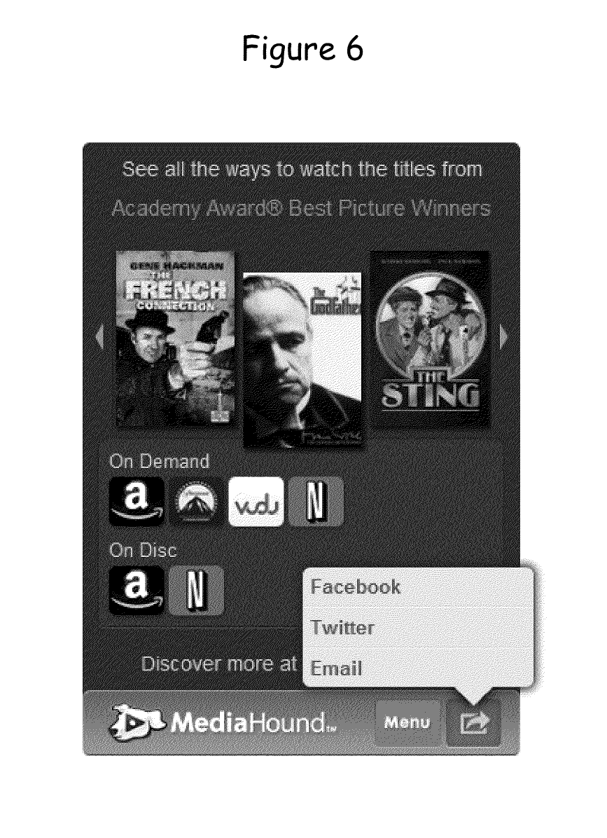

These examples are just a few of the possible ways consumer 178 could access content grouping records 152 and 154. Additionally, accessing these content grouping records via content grouping database 140 or any alternative web application may provide consumer 178 with additional features accessible via content discovery application 140 and features specific to content grouping records. For example, consumer 178 may share a content grouping record as a URL link via a social media post, email or other means of sharing to access it on the content discovery application, as shown in FIG. 6, or consumer 178 may share the content grouping record by inserting the embed code on an alternative web application. Both these and other features simplify the sharing of content grouping records, thereby simplifying the discovery of content. There are many more features within content discovery application 140 and accessible through content grouping records that one skilled in the art would find familiar to content discovery, including filtration or performance of content records by way of source authentication or prior ownership, and others mentioned within this document.

The feature “distribution status,” as used herein to characterize embodiments of the present invention, may embrace the release window (time period of availability) of the content, the distribution form of the content, the distribution format of the content, availability of the content according to one or more time windows, and availability of the content according to geographical location, for example. Using the example of feature film or movie content for the purposes of illustration, a release window for the content may comprise a theatrical release window during which the content may be available only as an event performance such as an in-theater screening. In addition, release windows for film or movie content may include a pay-per-view (PPV) release window and a home entertainment release window, for example. Furthermore, live shows and events, such as a music concert or comedian's act, take both date and the user's location into consideration in regards to release windows. Moreover, in some embodiments the release windows may be cumulative, such that a release window providing a more general release than its predecessor also includes the release to which its predecessor was limited. For instance, movie or film content available in a home entertainment release window as physical or digital media content, may also concurrently be available as PPV content available over a network and as event performance content in the form of an in-theater screening.

The distribution form of the content refers to the manner in which a consumer may acquire or experience the content. For example, distribution forms for movie or film content may include “available as an event performance,” e.g., in-theater screening, or “available as media content,” e.g., content stored and distributed as a digital stream, digital media file transfer, or content recorded and distributed on a physical media such as an optical disc. The distribution format of the content refers to alternatives within a distribution form. Thus, a distribution format for media content may be one of Digital Video Disc (DVD), Blu-ray, or digital download, for example.

As noted above, the distribution status may also correspond to the availability of the content during a particular time window. For example, the distribution status may reflect whether the content is presently available, that is to say available now in real time to the consumer, or whether although presently unavailable, e.g., unreleased or between release windows, and when the content will become available to the consumer in the future. In addition, the geographical location of the consumer may affect the distribution status of the entertainment content with respect to a particular consumer. Consequently, in some embodiments, the distribution status of content may be determined in a personalized way for the consumer according to his or her geographical location.

To continue with the specific example introduced above with reference to FIG. 1, if consumer 178 were to select the distribution form “available as an event performance”, content discovery application 140 or content groupings records 152 or 154 can identify local or regional venues at which such event performances are scheduled to occur. In addition, in some embodiments, content discovery application 140 or content groupings records 152 or 154 may also provide address and telephone information, Uniform Resource Identifier (URI) data such as a Uniform Resource Locator (URL), or other contact information for the identified providers, as well as perhaps pricing information and/or the dates and times of scheduled performances, as kept up-to-date by aggregator 130. For example, in one embodiment, consumer 178 may be redirected to a website of a provider to facilitate acquisition of a desired content unit from the provider. It is noted that although in some embodiments an identified provider of the content unit may be a third party commercial provider, e.g., a “big box” commercial retailer or online equivalent, in some embodiments, system 100 may be configured and provisioned to act itself as the provider. In other embodiments, content discovery application 140 or content groupings records 152 or 154 may be configured to provide analogous content discovery services to consumer 178 for other types of content, such as literary content, game content, and music content, for example. More generally, content discovery application 140 or content groupings records 152 or 154 can be configured to provide content discovery services to consumer 178 for any rich media content.

As shown in FIG. 1, content discovery application 140 may be accessed through network 112. In that instance, content discovery application 140 may comprise a web application, accessible over a packet network such as the Internet, and configured to execute as a server based application on server 110, for example. Alternatively, content discovery application 140 may reside on a server supporting a local area network (LAN), or be included in another type of limited distribution network. In another embodiment, content discovery application 140 may be stored on a computer-readable storage medium such as a computer hard-drive, computer based random-access memory (RAM), or a portable memory device such as a compact disc read -only memory (CD-ROM) or external Universal Serial Bus (USB) connected memory, for example.

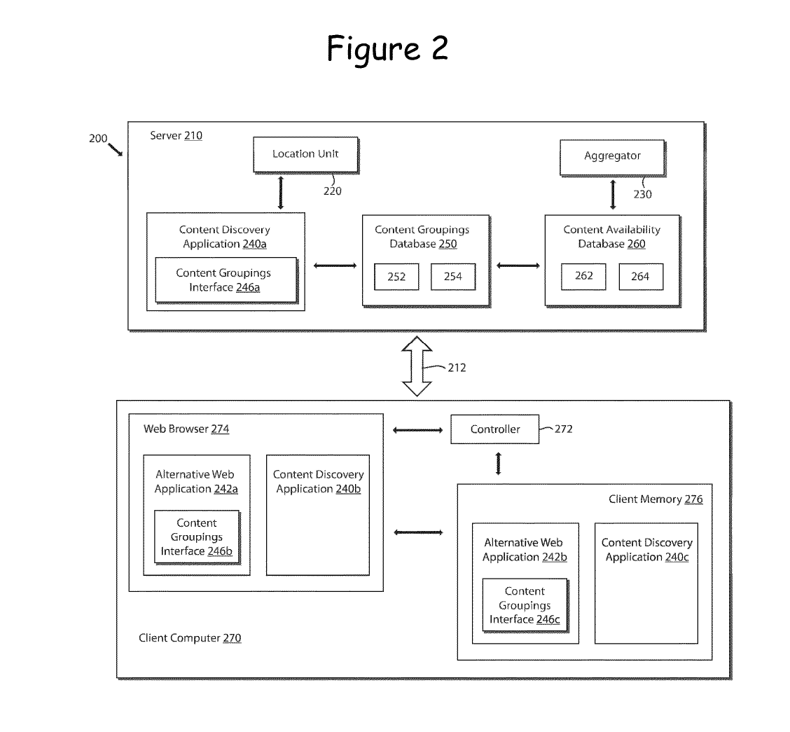

Turning now to FIG. 2, FIG. 2 shows a more detailed embodiment of system 200 for simplifying discovery, grouping and sharing of content availability for a consumer. System 200 in FIG. 2 includes client computer 270 interactively coupled to server 210 over communication link 212. Server 210 is shown to comprise optional location unit 220, aggregator 230, content discovery application 240a, content grouping interface 246a, content grouping database 250 including content grouping records 252a and 254a, and content availability database 260 including content records 262 and 264. Server 210, location unit 220, aggregator 230, content discovery application 240a, content grouping interface 246a, content grouping database 250 including content grouping records 252a and 254a, and content availability database 260 including content records 262 and 264 correspond respectively to server 110, location unit 120, aggregator 130, content discovery application 140, content groupings interface 146, content grouping database 150 including content grouping records 152 and 154, and content availability database 160 including content records 162 and 164, in FIG. 1. Moreover, client computer 270, in FIG. 2, corresponds to client computer 170, in FIG. 1. As shown in FIG. 2, client computer 270 comprises controller 272, web browser 274, client memory 276. Also shown in FIG. 2 is alternative web application 242a including content groupings interface 246b, content discovery application 240b, alternative web application 242b including content groupings interface 246c, and content discovery application 240c.

According to the embodiment shown in FIG. 2, content discovery application 240c and alternative web application 242b are located in client memory 276, having been received from server 210 via communication link 212. In the present embodiment, communication link 212 can represent download of content discovery application 240c or alternative web application 242b over a packet network, for example. In another embodiment, communication link 212 may represent transfer of content discovery application 240c or alternative web application 242b from a CDROM or other computer-readable storage medium. Once transferred, content discovery application 240c or alternative web application 242b may be stored in client memory 276 and executed locally on client computer 270, as a desktop application, for example. Communication link 212 is shown in FIG. 2 as a two-way communication, to represent ongoing communication between client computer 270, location unit 220, content availability database 260, and content groupings database 250.

According to the embodiment shown in FIG. 2, content discovery application 240b and alternative web application 242a are located in web browser 274, having been received from server 210 via communication link 212. In this embodiment, communication link 212 can represent download of content discovery application 240b or alternative web application 242a from a web site). Communication link 212 is shown as a two-way communication, to represent ongoing communication between client computer 270, location unit 220, content availability database 260, and content groupings database 250.

Controller 272 may be the central processing unit for client computer 270, for example, in which role controller 272 runs the client computer operating system and launches web browser 276 and web browser 274, and facilitates use of content discovery application 240b, alternative web application 242a, content discovery application 240c and alternative web application 142b. Alternative web application 142a and alternative web application 142b can be, for example, a web site or a native web application, such as a movie critic blog or an entertainment application on a television, for example. These are just two examples of alternative web applications, and one skilled in the art would understand there are many different forms of web applications, including applications on mobile phones, televisions, set top boxes as well as websites. Web browser 274, under the control of controller 272, may execute content discovery application 240b, alternative web application 242a, content discovery application 240c or alternative web application 142b to enable filtering, selection, grouping and sharing of content records 262 and 264 stored on content availability database 260 or to enable access, selection or sharing of content grouping records 252 and 254 stored in content groupings database 250. Web browser 274 may perform these actions through content groupings interface 246b or content groupings interface 246c or through content discover application 240b or content discovery application 240c.

What is claimed is:

1. A computer-implemented method for identifying and organizing media items available to a user, comprising:
providing a content availability database comprising a plurality of content records, each content record comprising data corresponding to one or more media items, wherein the data identifies a distribution status of each of the media items;
receiving a query from the user;
identifying one or more content records in the content availability database based on the query;
providing the identified content records to the user;
receiving from the user a content grouping record comprising one or more content records; and
saving the content grouping record in a content groupings database.

2. The method of claim 1, further comprising the step of sending a copy of the content grouping record to another consumer.

3. The method of claim 1, further comprising the step of uploading a copy of the content grouping record to another database.

4. The method of claim 1, wherein the content grouping record is created using input provided by the user on a content groupings interface of a device.

5. The method of claim 1, further comprising the step of identifying one or more providers of at least one of the media items.

6. The method of claim 1, further comprising the step of brokering a transaction between the user and the one or more providers of at least one of the media items.

7. The method of claim 1, further comprising the step of determining a location of the user.

8. The method of claim 7, further comprising the step of identifying one or more providers of at least one of the media items within a predetermined distance of the location of the user.
